(19) United States
(12) Patent Application Publication
(10) Pub. No.: US 2011/0134853 A1
(43) Pub. Date: Jun. 9, 2011

(54) METHOD FOR ALLOCATING MOBILE USER RESOURCE AND RESOURCE ALLOCATION SCHEDULER USING THE SAME

(76) Inventors: Xudong Zhu, Shanghai (CN); Mingli You, Shanghai (CN)

(21) Appl. No.: 12/672,560

(22) PCT Filed: Aug. 10, 2007
(86) PCT No.: PCT/CN2007/002402

§ 371 Date: Feb. 16, 2011

(51) Int. Cl. H04W 72/04

(52) U.S. Cl. 370/329

(57) ABSTRACT

Disclosed is a method for allocating mobile user resource, which comprises the steps of: randomly generating a resource allocation mapping sequence by a base station based on a hopping scheme, which has a variable hopping distance; and allocating communication resource by the base station to each UE within a cell, where the base station is present, based on the generated resource allocation mapping sequence. Since the hopping scheme is generated randomly, the resource allocation scheme according to the present invention may randomize a resource allocation procedure among different cells, thereby randomizing the inter-cell interference and decreasing dramatic changes of interference due to the user's movement.

### FIELD OF THE INVENTION

The present invention relates to a mobile communication field, and especially, to a method for allocating mobile user resource and a resource allocation scheduler using the same.

### BACKGROUND OF THE INVENTION

In an E-UTRAN system, frequency-selective (FS) scheduling through exploitation of channel condition is one of the main technologies in distributed dynamic radio resource radio resource management. However, large fluctuation of SIR (Signal to Interference Ratio) may be caused due to lacking knowledge of instant inter-cell co-channel interference, thereby infecting implementations of the radio link adaptation technologies.

In addition, in order to achieve reasonable cell edge performance and good fairness among users, the FS scheduling will also have to allocate more bandwidths to those cell-edge users in the severe inter-cell interference situation. This will degrade the bandwidth efficiency and thus the whole cell performance.

A scheme with reasonable complexity to handle with the inter-cell interference is important even when the FS scheduling is applied in an uplink of E-UTRAN. The FS scheduling may not be applicable in E-UTRAN due to channel estimation accuracy and application requirements in some scenarios such as when users are in high mobility and/or when real-time services such as VOIP (Voice over Internet Protocol) are transported and etc.

Therefore, the FH (Frequency Hopping) scheme is an alternative candidate to achieve the frequency diversity gain in multi-path frequency-selective channel as complimentary to FS scheduling especially for those situations where the FS scheduling is not applicable.

In the FH scheme, a UE (User Equipment) will be allocated discontinuous frequency resource according to a predefined pattern. By using the FH, it can reduce multi-path interference and avoid deep fading in wireless communication. Therefore, the frequency diversity gain can be achieved on a link layer.

FIG. 1(a) illustrates a normal RU (Resource Unit) allocation without frequency hopping for three users, UE A, UE B and UE C. As shown in FIG. 1(a), each UE is allocated one RU with 12 sub-carriers per TTI, and each TTI contains two sub-frames, which are called a first sub-frame and a second sub-frame respectively. In a case without frequency hopping, the first sub-frame and the second sub-frame use the same frequency band. The “first retransmission” as shown in FIG. 1(a) refers to a retransmission of Hybrid ARQ (Automatic Repeat Request). Since it is advised to use fixed non-adaptive retransmission patterns in the current radio standardization organization 3GPP, resource locations for retransmission (time versus frequency) are fixed, as shown in FIG. 1(a).

FIG. 1(b) illustrates a case with intra-TTI frequency hopping. Here, a distance in term of RU number between the first sub-frame and the second sub-frame within the same TTI is defined as a frequency hopping distance D. The frequency hopping pattern is a critical factor to affect the interference.

There is no scheme of FH pattern design that considers system level performance, so currently, a constant frequency hopping is applied, which is described in FIG. 2.

As illustrated in FIG. 2, a set of indices of the first sub-frame are set as S₁ₛₜ={firstIdx|1, 2, 3, 4, . . . }, which is consisted of sub-frame indices, and a set of indices of the second sub-frame is set as S_{2nd}={SecondIdx|1, 2, 3, 4, . . . }. When the frequency hopping scheme is applied, each UE will be allocated a resource indicator as a pair of a first sub-frame index and a second sub-frame index, {firstIdx, SecondIdx}. According to the FH pattern, the value of SecondIdx can be calculated by the following equation:

SecondIdx=mod(firstIdx+D_{fh},total_{—}RU_number) (1)

With a constant hopping distance pattern, where a UE in the same sector may have the same distance, the D_{fh} can be calculated by the following equation:

D_{fh}=STEP*(cell_{—}idx+1) (2)

Where, the parameter of STEP m equation (2) is a basic hopping distance, which is used for a whole system, and cell_idx is an index number of sector. FIG. 2 denotes a frequency-hopping pattern with the same distance. Therefore, the UE may be allocated resource pairs, {1, 3}, {2, 4}, {3, 5} . . . , here D_{fh} is 2.

With the constant hopping distance, each UE in the same cell can use the same hopping distance, thus the inter-cell interference can not be randomized.

### SUMMARY OF THE INVENTION

In order to solve the above problems, the present invention provides a random frequency hopping pattern, in which a variable hopping distance is provided among UEs in the same cell. With this pattern, the inter-cell interference can be randomized while keeping steady of interference.

According to an aspect of the present invention, a method for allocating mobile user resource is provided, which comprises steps of:

randomly generating a resource allocation mapping sequence by a base station based on a hopping scheme, which has a variable hopping distance; and
allocating communication resource by the base station to each UE within a cell based on the generated resource allocation mapping sequence.

According to another aspect of the present invention, a scheduler for allocating mobile communication resource is provided, which comprises:

a resource allocation mapping sequence generator adapted to randomly generate a resource allocation mapping sequence based on a hopping scheme, the resource allocation mapping sequence generator comprising a hopping distance generation module for generating a variable hopping distance; and
a resource allocator adapted to allocate communication resource to each UE within a cell based on the resource allocation mapping sequence generated by the resource allocation mapping sequence generator.

Since the hoping scheme is generated randomly, the resource allocation scheme according to the present invention may randomize a resource allocation procedure among difference cells, thereby randomizing the inter-cell interference and further reducing dramatic changes of interference due to the user's movement.

### BRIEF DESCRIPTION OF THE DRAWINGS

FIG. 1(a) is a schematic diagram of a resource allocation without using a hopping scheme in the prior art;

FIG. 1(b) is a schematic diagram of a resource allocation using a hopping scheme having a constant hopping distance in the prior art;

FIG. 2 is a schematic diagram of a hopping scheme for allocating resource to UEs using a constant hopping distance;

FIG. 3 is a schematic diagram of allocating resource to UEs using a variable hopping distance according to the present invention;

FIG. 4 is a flowchart of a resource allocation method according to the present invention;

FIG. 5 is a block diagram of a resource allocation scheduler according to the present invention; and

FIG. 6 is a schematic diagram of a hopping mapping relationship according to the present invention, which has a variable hopping distance generated.

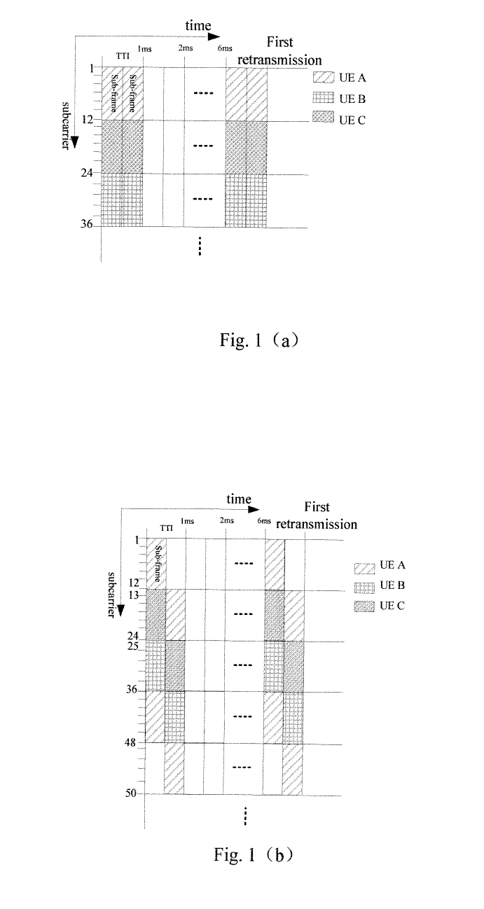

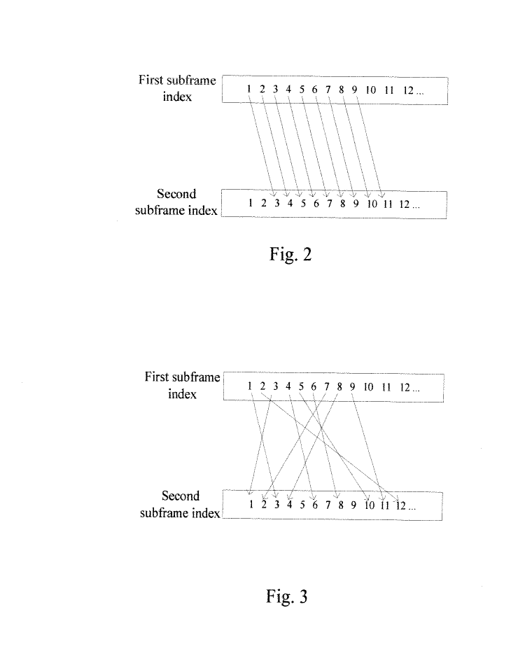

### DETAILED DESCRIPTION OF THE PREFERRED EMBODIMENTS

In order to achieve randomization of frequency hopping, the present invention provides a mobile user resource allocation scheme, where UEs in the same cell have different hopping distances. In the following, a resource allocation method according to the preferred embodiment of the present invention will be described by referring to FIGS. 3-5.

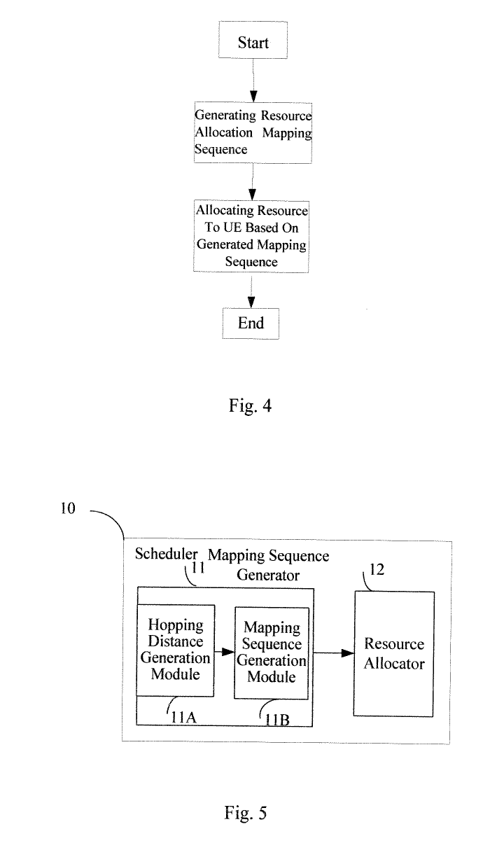

Firstly, as shown in FIG. 4, in a case that channel information is unknown, a Node B firstly generates a mapping relationship sequence according to a mapping relationship sequence generation method proposed in the present invention, and then allocates resource units to each UE within a cell in which the Node B locates, based on the generated mapping relationship sequence.

As shown in FIG. 5, a resource allocation scheduler 10 according to the present invention comprises a mapping sequence generator 11 and a resource allocator 12. Here, the mapping sequence generator 11 adopts the mapping relationship sequence generation method according to the present invention. The mapping sequence generator 11 comprises a hopping distance generation module 11A adapted to randomly generate a variable hopping distance; and a mapping sequence generation module 11 B adapted to generate a mapping sequence based on the generated hopping distance while removing mappings not satisfying specific conditions. This procedure will be described in detail in the following.

Similar with the conventional solution, a set of indices of the first sub-frame are set as S₁ₛₜ={firstIDX|1, 2, 3, 4, . . . }, which is consisted of sub-frame indices, and a set of indices of the second sub-frame is set as S_{2nd}={SecondIdx|1, 2, 3, 4, . . . }. When the frequency hopping scheme is applied, each UE will be allocated a resource indicator as a pair of a first sub-frame index and a second sub-frame index, {firstIdx, SecondIdx}. According to the FH pattern, the value of SecondIdx can be calculated by the following equation:

SecondIdx=mod(firstIdx+D_{fh},total_{—}RU_number) (1)

According to the present invention, the hopping distance D_{fh}, for equation (1) is:

D_{fh}=RandomVal.

Here, the RandomVal is determined by a mapping pattern. A difference between resource pairs respectively formed by the first sub-frame and the second sub-frame, is a random variable since the mapping pattern is generated in a random sequence manner.

FIG. 3 shows a mapping pattern, which is generated in the random sequence manner using the method according to the present invention. Therefore, resource pairs formed in FIG. 3 are {1, 3}, {2, 12}, {3, 1}, {5, 10} . . . . These resource pairs are allocated using a scheduling algorithm to UEs within a cell. Hopping distances of respective resource pairs are 2, 10, −2, 5, . . . , respectively. Therefore, the value of the hopping distance D_{fh} is a random variable.

In order to create a randomized FH, the following criteria shall be satisfied:

1) A sub-frame or sub-frame group in S₁ₛₜ has and only has one sub-frame or sub-frame group in S_{2nd}. That is, sub-frames or sub-frame groups in S₁ₛₜ respectively correspond to sub-frames or sub-frame groups in S_{2nd}.
2) RU overlap must be avoided between neighbor cells. That is, within a neighbor cell, the same firstIdx would be mapped to different SecondIdx.

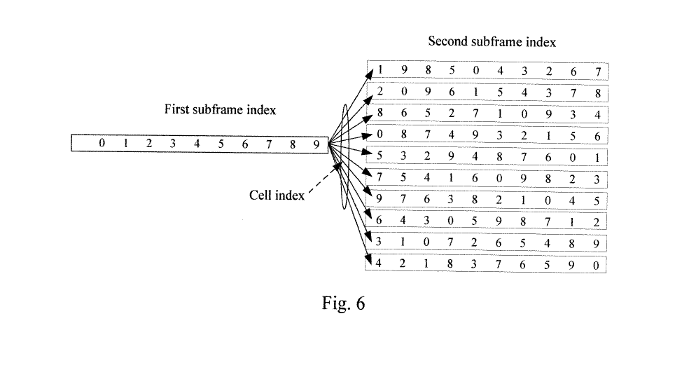

A mapping relationship is created based on the above criteria. In FIG. 6, available mapping relationship random sequences are illustrated by way of an example, where mapping relationships not satisfying the above criteria are removed.

Here, assume there are ten RUs in the whole bandwidth. Ten pairs of mapping relationships are generated according to the above criteria for the mapping relationship. Each cell will be allocated one mapping relationship, and cells that are not neighboring can reuse the same mapping relationship. Each base station allocates RU resource to each UE within a cell under control of the base station based on a mapping relationship sequence of the cell. That is, the base station randomly allocates a resource pair to each UE. Assuming the mapping relationships for allocation in this cell are as shown in FIG. 3, resource allocated to each UE within the cell are: {1, 3}, {2, 12}, {3, 1}, {5, 10}, respectively.

With the mapping method according to the present invention, a variance of the inter-cell interference can be decreased. A simulation result for IoT (Interference over Thermal) will be given in the following.

Table 1 shows variances and mean values of interference under TU (Typical Urban) 30 km/h. It can be seen from Table 1 that a randomized mapping pattern provides the best variance performance. Therefore, the randomized frequency hopping pattern can decrease the variation of interference, compared to the scheme without using hopping, it is 50% gain. Also, 39% gain can be obtained over the constant distance frequency hopping scheme.

TABLE 1
Variance and mean value of interference under TU 30 km/h

| | | | Gain over w/o |
|---|---|---|---|
| FH pattern | Variance (dB) | Mean (dBm) | FH |
| without hopping: | 20.8008902622 | 88.2439035314 | — |
| constant hopping | 15.6621218912 | −88.33115614 | 24.7% |
| distance and | | | |
| basic step 1 | | | |
| constant hopping | 15.4698038957 | 88.4035380568 | 25.63% |
| distance and | | | |
| basic step 3 | | | |
| variable hopping | 9.39370874548 | 89.2119570647 | 54.84% |
| distance | | | |

What is claimed is:

1. A method for allocating resource to a mobile user in a mobile communication, comprising steps of:
generating a resource allocation mapping sequence by a base station based on a hopping scheme, which is generated randomly; and
allocating communication resource by the base station to each UE within a cell, where the base station is present, based on the generated resource allocation mapping sequence,
wherein the hopping scheme has a variable hopping distance.

2. A method as set forth in claim 1, wherein the resource allocation mapping sequence comprises indices of a first sub-frame and indices of a second sub-frame, which are obtained based on the indices of the first sub-frame and the hopping distance.

3. A method as set forth in claim 2, wherein the hopping distance is generated randomly, so that:
1) the indices of the first sub-frame correspond to the indices of the second sub-frame, respectively; and
2) one index of the first sub-frame is mapped to difference indices of the second sub-frame for a mapping sequence of a neighbor cell.

4. A scheduler for allocating mobile communication resource, comprising:
a resource allocation mapping sequence generator adapted to randomly generate a resource allocation mapping sequence based on a hopping scheme; and
a resource allocator adapted to allocate communication resource to each UE within a cell based on the resource allocation mapping sequence generated by the resource allocation mapping sequence generator,
wherein the resource allocation mapping sequence generator comprises a hopping distance generation module for generating a variable hopping distance.

5. A scheduler as set forth in claim 4, wherein the resource allocation mapping sequence generator is adapted to generate a resource allocation mapping sequence including indices of a first sub-frame and indices of a second sub-frame, which are obtained based on the indices of the first sub-frame and the hopping distance.

6. A scheduler as set forth in claim 5, wherein the hopping distance generation module is adapted to randomly generate the hopping distance, so that:
the indices of the first sub-frame corresponds to the indices of the second sub-frame, respectively; and
one index of the first sub-frame is mapped to difference indices of the second sub-frame for a mapping sequence allocated to a neighbor cell.
